(19) United States
(12) Patent Application Publication
(10) Pub. No.: US 2024/0271245 A1
(43) Pub. Date: Aug. 15, 2024

(54) ORE CRUSHING METHOD AND PELLET PRODUCTION METHOD

(71) Applicant: JFE STEEL CORPORATION, Tokyo (JP)

(72) Inventors: Kenta TAKEHARA, Tokyo (JP); Tetsuya YAMAMOTO, Tokyo (JP); Takahide HIGUCHI, Tokyo (JP); Kenya HORITA, Tokyo (JP); Yuji IWAMI, Tokyo (JP); Shohei FUJIWARA, Tokyo (JP); Yuya MORITA, Tokyo (JP); Toshiyuki HIROSAWA, Tokyo (JP); Daisuke IGAWA, Tokyo (JP)

(73) Assignee: JFE STEEL CORPORATION, Tokyo (JP)

(21) Appl. No.: 18/568,932

(22) PCT Filed: Mar. 4, 2022
(86) PCT No.: PCT/JP2022/009357

§ 371 Date: Dec. 11, 2023

(30) Foreign Application Priority Data
Jun. 11, 2021 (JP) 2021-097698

(51) Int. Cl. C22B 1/24

(52) U.S. Cl. CPC C22B 1/2406

(57) ABSTRACT

Provided is an ore crushing method capable of efficiently crushing iron ores that are difficult to finely crush. The ore crushing method includes coarsely crushing the iron ores to reduce the proportion of particles with a particle size of greater than or equal to 1 mm, and then finely crushing the iron ores to increase the proportion of particles with a particle size of less than 63 μm. The average pore size of the iron ores is preferably less than or equal to 10 μm, the proportion of the particles with a particle size of greater than or equal to 1 mm in the iron ores is preferably greater than or equal to 30 mass %, the iron ores are preferably coarsely crushed so that the proportion of the particles with a particle size of greater than or equal to 1 mm becomes less than or equal to 20 mass %, the iron ores are preferably finely crushed so that the proportion of the particles with a particle size of less than 63 μm becomes greater than or equal to 70 mass %, and the iron ores are preferably finely crushed with a wet ball mill. A pellet production method is also provided that includes granulating a raw material, which includes the iron ores crushed with the ore crushing method, into pellets.

### TECHNICAL FIELD

The present invention relates to an ore crushing method, and also relates to a pellet production method that uses as a raw material iron ores processed with the ore crushing method.

### BACKGROUND ART

When iron ores are used in a smelting process, sintered ores or pellets (which may be either baked or not baked) are produced through a granulation step. It is known that crushing ores is effective in improving the granulation operation for improving the yields and productivity of sintered ores or pellets.

For example, Patent Literature 1 discloses a technique for producing sintered ores involving using, as granulated raw material, fine ores that have been crushed in advance.

Patent Literature 2 discloses a crushing method for iron-ore raw material using a roll crusher, which includes mixing a first iron-ore raw material as a crushing target with a second iron-ore raw material, which is harder than the first iron-ore raw material, as a crushing auxiliary material, and putting the thus mixed first and second iron-ore raw materials into the roll crusher so as to crush them. The crushed iron ores are granulated into pellets as a raw material to be sintered.

Patent Literatures 3 and 4 respectively disclose: to granulate iron ores with a high crystal water content, a sintered ore production method that includes sieving iron ores with a predetermined mesh size, crushing the remaining iron ores and the like on the sieve, mixing the crushed iron ores and the like with iron ores and the like that have passed through the sieve, and then granulating the mixture; and a pretreatment method for a raw material to be sintered that includes subjecting the raw material to be sintered to compression crushing using a roller press crusher, and then granulating the crushed material.

Patent Literature 5 discloses a sintered ore production method that includes crushing porous iron ores before granulating them.

### CITATION LIST

### Patent Literature

Patent Literature 1: JP-2016-17211A
Patent Literature 2: International Publication No. WO 2010/113571
Patent Literature 3: JP-2008-261016A
Patent Literature 4: JP-2007-162127A
Patent Literature 5: JP-2007-138244A

### SUMMARY OF INVENTION

### Technical Problem

The conventional techniques have the following problems.

That is, the conventional techniques are problematic in that they are insufficient as techniques for crushing powdery iron ores including coarse particles that are difficult to finely crush. The technique disclosed in Patent Literature 1 only describes crushing, and does not take any measure against the mixing of ores with low crushability. The technique disclosed in Patent Literature 2 is not intended to crush an iron-ore raw material with relatively high hardness that is used as a crushing auxiliary material.

The techniques disclosed in Patent Literatures 3 and 4 are not intended to solve the problem with the mixing of ores that are difficult to crush, either.

The technique disclosed in Patent Literature 5 is intended to solve the problem that a large amount of water would be needed to granulate a porous raw material, and is not intended to solve the problem with the mixing of ores that are difficult to crush, either.

An object of the present invention is to provide an ore crushing method that can efficiently and finely crush iron ores that are difficult to finely crush. In addition, it is another object of the present invention to provide a pellet production method that uses as a raw material iron ores processed with the crushing method.

### Solution to Problem

The inventors have found that coarsely crushing iron ores that are difficult to crush in advance allows the iron ores to be finely crushed efficiently.

An ore crushing method according to the present invention that advantageously solves the foregoing problem is an ore crushing method for crushing ores including iron ores. The method includes coarsely crushing iron ores to reduce the proportion of particles with a particle size of greater than or equal to 1 mm, and finely crushing the coarsely crushed iron ores to increase the proportion of particles with a particle size of less than 63 μm.

In the ore crushing method according to the present invention, it is considered that the following can be more preferable solution means, for example:
(a) the average pore size of the iron ores before being coarsely crushed is less than or equal to 10 μm,
(b) the proportion of particles with a particle size of greater than or equal to 1 mm in the iron ores before being coarsely crushed is greater than or equal to 30 mass %, and the iron ores are coarsely crushed so that the proportion of the particles with a particle size of greater than or equal to 1 mm becomes less than or equal to 20 mass %,
(c) the iron ores are finely crushed so that the proportion of particles with a particle size of less than 63 μm becomes greater than or equal to 70 mass %, and
(d) the iron ores are finely crushed with a wet ball mill.

A pellet production method according to the present invention that advantageously solves the foregoing problem includes granulating a raw material, which includes the iron ores crushed with any one of the foregoing ore crushing methods, into pellets.

### Advantageous Effects of Invention

According to the present invention, even when iron ores include those that are difficult to finely crush, it is possible to finely crush the iron ores efficiently by coarsely crushing them in advance. Thus, such a technique can be suitably used for the production of a sintered-ore raw material or pellets.

### BRIEF DESCRIPTION OF DRAWINGS

FIG. 1 is a schematic view illustrating the structure of a ball mill that can be suitably used for fine crushing according to an embodiment of the present invention.

### DESCRIPTION OF EMBODIMENTS

Hereinafter, an embodiment of the present invention will be specifically described. Note that the drawing is only schematic, and may be different from the actual one. In addition, the following embodiment illustrates examples of a device and a method for embodying the technical idea of the present invention, and thus, the configuration of the embodiment is not limited to the following configuration. That is, various changes may be made to the technical idea of the present invention within the technical scope recited in the claims.

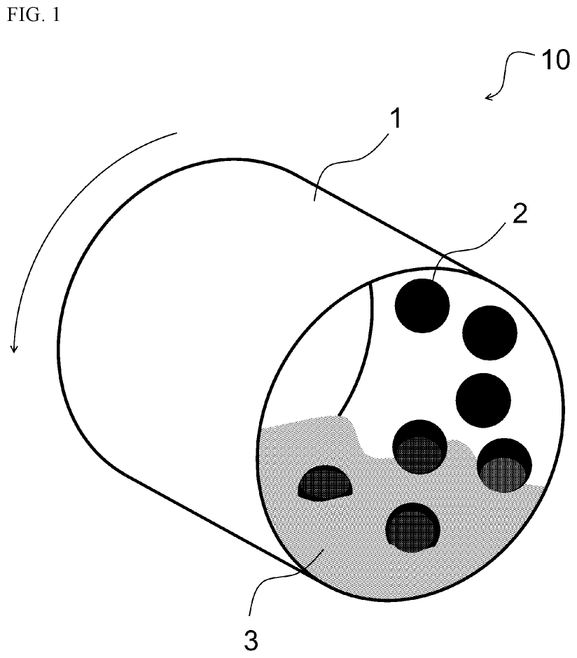

FIG. 1 is a schematic view of a ball mill that can be suitably used for fine crushing according to an embodiment of the present invention. In the ball mill that is a crusher 10, balls 2 of a hard material, such as alumina, that are substantially spherical in shape, a processing object 3 that is an object to be crushed, and a liquid (if necessary) are put into a rotary container 1 that is substantially cylindrical in shape, so that the balls roll with the rotation of the rotary container 1, thereby causing the processing object 3 to be finely crushed between the balls 2 and between the ball 2 and the rotary container 1. For example, it is possible to use the rotary container 1 with a cylinder diameter of 0.67 m, a cylinder length of 0.5 m, a rotation power of 3.7 kW, and a rotating speed of about 40 rpm; and the balls 2 made of alumina with a diameter of 20 to 25 mm and a filling weight of 140 kg. Note that not only the foregoing ball mill, but also a bead mill, a jet mill, or a roller mill, for example, may be used as the crusher 10. In the present embodiment, “fine crushing” refers to a crushing process for mainly iron ores to increase the proportion of particles with a particle size of −63 μm, and is a crushing process for iron ores to increase the proportion of particles with a particle size of −63 μm by an amount greater than the reduced proportion of particles with a particle size of +1 mm. Note that in the present embodiment, particles with a particle size of −63 μm mean those that have passed through a sieve with mesh openings of 63 μm after sieving, and such particles are also expressed as particles with a particle size of less than 63 μm. Meanwhile, particles with a particle size of +1 mm mean those that remain on a sieve with mesh openings of 1 mm after sieving, and such particles are also expressed as particles with a particle size of greater than or equal to 1 mm.

The granularity of iron ores is improved as the iron ores include more particles with a particle size of −63 μm. Three types of iron ores described in Table 1 were finely crushed with the foregoing ball mill for 30 minutes. Then, the iron ores were sieved to evaluate the proportion of particles with a particle size of −63 μm. Table 1 illustrates the results. As illustrated in Table 1, iron ores with a smaller average pore size d_{A} have a lower proportion of particles with a particle size of −63 μm, although all of the iron ores were finely crushed for the same period of time. Consequently, it is found that Ores B and C, which are iron ores with an average pore size d_{A} of less than or equal to 10 μm, have lower fine crushability, that is, can be finely crushed less easily than Ores A that are iron ores with an average pore size d_{A} of greater than 10 μm. Herein, the average pore size d_{A} was determined by measuring a pore size distribution using mercury porosimetry in compliance with the JIS R1655:2003, and then determining a value of 50% from the cumulative pore volume of pores with a pore size of 3.6 nm to 200 μm. Herein, the pore size is a cylinder diameter calculated with the Washburn's equation of the following Expression (1), provided that open pores are cylindrical in shape.

$$d = - 4 σ ( cos θ ) / P \qquad ( 1 )$$

In Expression (1) above, d represents the pore size (m), σ represents the surface tension (N/m) of mercury, θ represents the contact angle (°) between the measured sample and mercury, and P represents the pressure (Pa) applied to mercury. For example, AutoPore IV9520 (manufactured by Micromeritics Instruments Corporation) can be used as a measuring device. The surface tension of mercury was set to 0.48 N/m, and the contact angle between mercury and the sample was set to 140°.

TABLE 1

| | | | | | | | After |
|---|---|---|---|---|---|---|---|
| | | | | Raw material characteristics | | | fine |
| Types | Chemical composition | | | | | Average pore | crushing |
| of | T.Fe | SiO₂ | Al₂O₃ | +1 mm | −63 μm | size d_{A} | −63 μm |
| ores | mass % | mass % | mass % | mass % | mass % | μm | mass % |
| OreA | 56.4 | 6.6 | 1.8 | 37.2 | 9.4 | 22.5 | 71.6 |
| OreB | 64.8 | 1.5 | 1.5 | 42.7 | 2.4 | 9.3 | 60.7 |
| OreC | 63.6 | 6.3 | 0.7 | 36.3 | 6.4 | 5.3 | 50.3 |

Next, the iron ores: Ores B with an average pore size d_{A} of less than or equal to 10 μm, which have poor fine crushability, and the iron ores: Ores A with an average pore size d_{A} of greater than 10 μm were coarsely crushed with a jaw crusher in advance, and then, the proportion of particles with a particle size of +1 mm was measured. Then, the coarsely crushed iron ores were finely crushed in the dry state with a ball mill such as the one illustrated in FIG. 1 for 30 minutes. Then, the proportion of particles with a particle size of −63 μm in the finely crushed iron ores was measured. Then, 2 mass % slaked lime was added to and mixed with the finely crushed iron ores, and the mixture was granulated with a pelletizer under a moisture condition of 7 mass %. Then, the crushing strength of pellets obtained through the granulation was measured with Autograph under a speed condition of 1 mm/min. The crushing strength was determined from the average crushing strength of 10 pellets. Typically, pellets obtained through granulation preferably have a crushing strength of greater than or equal to 49 N from the perspective of suppressing powdering during transport, for example. Tables 2 and 3 below illustrate the test conditions and the measurement results of the crushing strength. In the present embodiment, “coarse crushing” refers to a crushing process for mainly iron ores to reduce the proportion of particles with a particle size of +1 mm, and is a crushing process for iron ores to reduce the proportion of particles with a particle size of +1 mm by an amount greater than the increased proportion of particles with a particle size of −63 μm.

TABLE 2

| | | | | | Pellets |
|---|---|---|---|---|---|
| | Before fine crushing | | After fine crushing | | Crushing |
| | +1 mm | −63 μm | +1 mm | −63 μm | strength |
| Test No. | mass % | mass % | mass % | mass % | N |
| Test 1 | 42.7 | 2.4 | 8.1 | 60.7 | 16.7 |
| Test 2 | 18.9 | 16.7 | 5.5 | 73.3 | 79.4 |
| Test 3 | 9.7 | 24.8 | 4.0 | 80.0 | 149.0 |
| Test 4 | 1.2 | 32.0 | 0.8 | 92.6 | 188.0 |

Table 2 illustrates the results of the iron ores: Ores B. As illustrated in Table 2, coarsely crushing the iron ores: Ores B with low fine crushability in advance to reduce the proportion of particles with a particle size of +1 mm leads to an increase in the proportion of particles with a particle size of −63 μm after fine crushing is performed for 30 minutes. From the results, it is found that when iron ores with an average pore size d_{A} of less than or equal to 10 μm are finely crushed, it is possible to efficiently perform fine crushing to increase the proportion of particles with a particle size of −63 μm by performing coarse crushing in advance to reduce the proportion of particles with a particle size of greater than or equal to 1 mm.

About 10 seconds were required to coarsely crush the iron ores: Ores B in which the proportion of particles with a particle size of +1 mm was 42.7 mass % with the jaw crusher until the proportion of the particles with a particle size of +1 mm became 18.9 mass %. Meanwhile, about 30 minutes were additionally required to finely crush the iron ores: Ores B in which the proportion of particles with a particle size of −63 μm is 60.7 mass after finely crushed, with the ball mill until the proportion of the particles with a particle size of −63 μm became 73.3 mass %.

This can confirm that when iron ores in which the proportion of particles with a particle size of +1 mm is 42.7 mass % (which is greater than or equal to 30 mass %) are coarsely crushed in advance so that the proportion of the particles with a particle size of +1 mm becomes 18.9 mass % (which is less than or equal to 20 mass %), it is possible to increase the proportion of particles with a particle size of −63 μm to greater than or equal to 70 mass % in a short time. Further, it is also found that granulating iron ores in which the proportion of particles with a particle size of −63 μm is greater than or equal to 70 mass % to form pellets can produce pellets with a crushing strength of greater than or equal to 49 N that can suppress the powdering thereof during transport, for example.

TABLE 3

| | | | | | Pellets |
|---|---|---|---|---|---|
| | Before fine crushing | | After fine crushing | | Crushing |
| | +1 mm | −63 μm | +1 mm | −63 μm | strength |
| Test No. | mass % | mass % | mass % | mass % | N |
| Test 6 | 37.2 | 9.4 | 7.7 | 71.6 | 72.3 |
| Test 7 | 13.3 | 21.1 | 4.1 | 82.8 | 152.2 |

Table 3 is a table illustrating the results of the iron ores: Ores A. As illustrated in Table 3, coarsely crushing the iron ores: Ores A in advance to reduce the proportion of particles with a particle size of +1 mm also leads to an increase in the proportion of particles with a particle size of −63 μm after fine crushing is performed for 30 minutes. In addition, about 10 seconds were required to coarsely crush the iron ores: Ores A in which the proportion of particles with a particle size of +1 mm was 37.2 mass % with the jaw crusher until the proportion of the particles with a particle size of +1 mm became 13.3 mass %. Meanwhile, about 12 minutes were additionally required to finely crush the iron ores: Ores A in which the proportion of particles with a particle size of −63 μm after finely crushed is 71.6 mass %, with the ball mill until the proportion of the particles with a particle size of −63 μm became 82.8 mass %. Accordingly, finely crushing the iron ores: Ores A with an average pore size d_{A} of greater than 10 μm after coarsely crushing them was able to obtain the time saving effect of about 12 minutes. Meanwhile, finely crushing the iron ores: Ores B with an average pore size d_{A} of less than or equal to 10 μm after coarsely crushing them was able to obtain the time-saving effect of about 30 minutes. From the results, it is found that the ore crushing method according to the present embodiment is more preferably applied to iron ores with an average pore size d_{A} of less than or equal to 10 μm.

Note that the ore crushing method according to the present embodiment is also applicable to iron ores that are unclear as to whether the iron ores include those that are difficult to finely crush. Accordingly, even when the iron ores include those that are difficult to finely crush, it is possible to efficiently perform fine crushing to increase the proportion of particles with a particle size of −63 μm.

### First Embodiment

The inventors have found a first embodiment for improving the efficiency of crushing iron ores from the foregoing study. That is, iron ores are coarsely crushed with a crushing machine, such as a roller press or a jaw crusher, in advance so that the proportion of particles with a particle size of +1 mm is reduced. Then, the resulting iron ores are finely crushed with a crushing machine, such as a ball mill, so that the proportion of particles with a particle size of −63 μm is increased. In this manner, coarsely crushing iron ores in advance allows the iron ores to be finely crushed efficiently even when the iron ores include those that are difficult to finely crush. Note that the iron ores may include other ores. In such a case, all the ores may be coarsely crushed together so that the proportion of iron ore particles with a particle size of greater than or equal to 1 mm is reduced, and then, the resulting ores may be finely crushed.

### Second Embodiment

A second embodiment has been found from the fact that there is a correlation between the average pore size d_{A} and the fine crushability of iron ores. That is, iron ores with an average pore size d_{A} of greater than 10 μm, which have excellent fine crushability, may be directly sent to a crushing machine, such as a ball mill. Meanwhile, it is preferable that iron ores with an average pore size d_{A} of less than or equal to 10 μm, which have poor fine crushability, be coarsely crushed in advance so that the proportion of particles with a particle size of +1 mm is reduced, and then be sent to a crushing machine, such as a ball mill, to be finely crushed therein. In this manner, identifying iron ores with poor fine crushability to coarsely crush them can reduce the amount of iron ores to be coarsely crushed in advance. This allows for more efficient crushing of the iron ores.

### Third Embodiment

The inventors have found from the foregoing study a third embodiment for improving the efficiency of crushing iron ores in which the proportion of particles with a particle size of greater than or equal to 1 mm is greater than or equal to 30 mass %. That is, iron ores in which the proportion of particles with a particle size of greater than or equal to 1 mm is greater than or equal to 30 mass % are coarsely crushed with a crushing machine, such as a roller press or a jaw crusher, so that the proportion of the particles with a particle size of greater than or equal to 1 mm becomes less than or equal to 20 mass %. Then, the resulting iron ores are finely crushed with a crushing machine, such as a ball mill. In this manner, coarsely crushing iron ores in advance allows the iron ores to be finely crushed efficiently. Note that the proportion of the particles with a particle size of +1 mm after the coarse crushing is preferably less than or equal to 10 mass %. The lower limit of the proportion of the particles with a particle size of +1 mm is not limited to a particular value, and may be zero. In addition, the iron ores may include other ores. In such a case, all the ores may be coarsely crushed together so that the proportion of iron ore particles with a particle size of greater than or equal to 1 mm becomes less than or equal to 20 mass %, and then, the resulting ores may be finely crushed.

### Fourth Embodiment

A fourth embodiment is based on the finding obtained in granulating the crushed iron ores into pellets. That is, a process of finely crushing iron ores is performed to finely crush the iron ores so that the proportion of particles with a particle size of −63 μm becomes greater than or equal to 70 mass %. This can increase the crushing strength of pellets obtained through granulation, and thus can suppress powdering of the pellets during transport. Preferably, the iron ores are finely crushed so that the proportion of the particles with a particle size of −63 μm becomes greater than or equal to 80 mass %. The upper limit of the proportion of the particles with a particle size of −63 μm is not limited to a particular value, but is about 98 mass % in consideration of a load that applied during crushing.

### Fifth Embodiment

A fifth embodiment has been developed from the perspective of preventing dust during fine crushing. That is, a wet ball mill is used as a fine crushing device. The same coarsely crushed iron ores as those of test No. Test 2 in Table 2 were finely crushed with a dry ball mill (Test 2) and a wet ball mill (Test 5), and were then granulated into pellets, and the crushing strength of the pellets was measured as in Table 2. Table 4 below illustrates the proportion of particles with a particle size of +1 mm before the fine crushing, the proportion of particles with a particle size of −63 μm after the fine crushing, and the measurement results of the crushing strength of the obtained pellets. As illustrated in Table 4, the proportion of particles with a particle size of −63 μm of the test No. Test 5 is higher than that of the test No. Test 2. From the results, it is found that iron ores can be finely crushed more efficiently with a wet ball mill than with a dry ball mill.

TABLE 4

| | | | | | | Pellets |
|---|---|---|---|---|---|---|
| | Before fine crushing | | Fine | After fine crushing | | Crushing |
| | +1 mm | −63 μm | crushing | +1 mm | −63 μm | strength |
| Test No. | mass % | mass % | condition | mass % | mass % | N |
| Test 2 | 18.9 | 16.7 | Dry | 5.5 | 73.3 | 79.4 |
| Test 5 | 18.9 | 16.7 | Wet | 4.1 | 81.2 | 132.8 |

### INDUSTRIAL APPLICABILITY

With the ore crushing method according to the present invention, even when iron ores include those that are difficult to finely crush, it is possible to finely crush the iron ores efficiently by coarsely crushing them in advance. Such finely crushed iron ores have excellent granularity. Thus, using the crushing method for the production of a sintered-ore raw material or pellets is industrially advantageous.

### REFERENCE SIGNS LIST

1 rotary container
2 ball
3 processing object
10 crusher (ball mill)

1. An ore crushing method for crushing ores including iron ores, wherein the ore crushing method comprises
coarsely crushing the iron ores to reduce a proportion of particles with a particle size of greater than or equal to 1 mm and
finely crushing the coarsely crushed iron ores to increase a proportion of particles with a particle size of less than 63 m.

2. The ore crushing method according to claim 1, wherein
an average pore size of the iron ores before being coarsely crushed is less than or equal to 10 m.

3. The ore crushing method according to claim 1, wherein
the proportion of the particles with a particle size of greater than or equal to 1 mm in the iron ores before being coarsely crushed is greater than or equal to 30 mass % and
the iron ores are coarsely crushed so that the proportion of the particles with a particle size of greater than or equal to 1 mm becomes less than or equal to 20 mass %.

4. The ore crushing method according to claim 1, wherein
the iron ores are finely crushed so that the proportion of the particles with a particle size of less than 63 m becomes greater than or equal to 70 mass %.

5. The ore crushing method according to claim 1, wherein
the iron ores are finely crushed with a wet ball mill.

6. A pellet production method, wherein the pellet production method comprises granulating a raw material into pellets, the raw material including the iron ores crushed with the ore crushing method according to claim 1.

7. The ore crushing method according to claim 2, wherein
the proportion of the particles with a particle size of greater than or equal to 1 mm in the iron ores before being coarsely crushed is greater than or equal to 30 mass % and
the iron ores are coarsely crushed so that the proportion of the particles with a particle size of greater than or equal to 1 mm becomes less than or equal to 20 mass %.

8. The ore crushing method according to claim 2, wherein
the iron ores are finely crushed so that the proportion of the particles with a particle size of less than 63 m becomes greater than or equal to 70 mass %.

9. The ore crushing method according to claim 3, wherein
the iron ores are finely crushed so that the proportion of the particles with a particle size of less than 63 m becomes greater than or equal to 70 mass %.

10. The ore crushing method according to claim 7, wherein
the iron ores are finely crushed so that the proportion of the particles with a particle size of less than 63 m becomes greater than or equal to 70 mass %.

11. A pellet production method, wherein the pellet production method comprises granulating a raw material into pellets, the raw material including the iron ores crushed with the ore crushing method according to claim 2.

12. A pellet production method, wherein the pellet production method comprises granulating a raw material into pellets, the raw material including the iron ores crushed with the ore crushing method according to claim 3.

13. A pellet production method, wherein the pellet production method comprises granulating a raw material into pellets, the raw material including the iron ores crushed with the ore crushing method according to claim 4.

14. A pellet production method, wherein the pellet production method comprises granulating a raw material into pellets, the raw material including the iron ores crushed with the ore crushing method according to claim 5.

15. A pellet production method, wherein the pellet production method comprises granulating a raw material into pellets, the raw material including the iron ores crushed with the ore crushing method according to claim 7.

16. A pellet production method, wherein the pellet production method comprises granulating a raw material into pellets, the raw material including the iron ores crushed with the ore crushing method according to claim 8.

17. A pellet production method, wherein the pellet production method comprises granulating a raw material into pellets, the raw material including the iron ores crushed with the ore crushing method according to claim 9.

18. A pellet production method, wherein the pellet production method comprises granulating a raw material into pellets, the raw material including the iron ores crushed with the ore crushing method according to claim 10.
